(19) United States
(12) Patent Application Publication
(10) Pub. No.: US 2026/0237245 A1
(43) Pub. Date: Aug. 13, 2026

(54) SYSTEM AND METHOD FOR BIOMETRIC ENROLLMENT USING NEURAL NETWORK

(71) Applicant: Synaptics Incorporated, San Jose, CA (US)

(72) Inventors: Han Ching Yeh, Taipei City (TW); Shao-Wei Huang, Taipei City (TW); Chien-Ming Lu, Taipei City (TW); Chiu Po Hung, Taipei City (TW)

(21) Appl. No.: 19/538,010

(22) Filed: Feb. 12, 2026

Related U.S. Application Data
(60) Provisional application No. 63/757,421, filed on Feb. 12, 2025.

(51) Int. Cl. G06V 40/50; G06V 10/44; G06V 10/62; G06V 10/764; G06V 10/82; G06V 40/12; G06V 40/13

(52) U.S. Cl. CPC G06V 40/50; G06V 10/44; G06V 10/62; G06V 10/764; G06V 10/82; G06V 40/1306; G06V 40/1353; G06V 40/1359; G06V 40/1365

(57) ABSTRACT

An input device for fingerprint enrollment is provided. The input device includes a fingerprint sensor and a processing system. The processing system is configured to initiate a fingerprint enrollment process to enroll a fingerprint of a user; receive a first enrollment input based on touch data obtained by the fingerprint sensor; process the first enrollment input to extract one or more features corresponding to the fingerprint; determine, based on the first enrollment input, whether to collect a second enrollment input; and based on a determination not to collect a second enrollment input, generate a fingerprint template for the fingerprint. The fingerprint template indicates a set of features extracted from one or more enrollment inputs processed in the fingerprint enrollment process. The one or more enrollment inputs comprise the first enrollment input.

### CROSS-REFERENCE TO RELATED APPLICATIONS

This patent application claims the benefit of U.S. Provisional Patent Application No. 63/757,421, filed Feb. 12, 2025, which is incorporated by reference herein in its entirety.

### TECHNICAL FIELD

This disclosure generally relates to biometric systems.

### BACKGROUND

Biometric authentication systems are used for authenticating users of devices incorporating the authentication systems. Among other things, biometric sensing technology can provide a reliable, non-intrusive way to verify individual identity for authentication purposes.

By way of example, fingerprints, like various other biometric characteristics, are based on unalterable personal characteristics and thus are a reliable mechanism to identify individuals. There are many potential applications for utilization of biometric and fingerprint sensors. For example, electronic fingerprint sensors may be used to provide access control in stationary applications, such as security checkpoints. Electronic fingerprint sensors may also be used to provide access control in portable applications, such as portable computers, personal data assistants (PDAs), cell phones, gaming devices, navigation devices, information appliances, data storage devices, and the like. Accordingly, some applications, particularly portable applications, may require electronic fingerprint sensing systems that are compact, highly reliable, and inexpensive.

Some biometric authentication systems use an enrollment process where a user enrolls a valid biometric into the system, e.g., one or more fingerprints of the user. Such systems typically require a set number of valid touches to complete enrollment, with the number chosen to balance performance and user experience. Current methods mainly reject duplicate or poor-quality touches but don't adjust the process based on individual user behavior or conditions. Forcing a fixed number of valid touches for all users leads to inefficiencies, unnecessary redundancy, and a suboptimal user experience, particularly for those who do not require the extra steps.

### SUMMARY

This summary is provided to introduce a selection of concepts in a simplified form that are further described below. This summary is not intended to necessarily identify key features or essential features of the present disclosure, nor is it intended to limit the scope of the claimed subject matter.

A first aspect of the present disclosure provides an input device. The input device includes a fingerprint sensor and a processing system. The fingerprint sensor includes a plurality of sensor electrodes configured to obtain touch data. The processing system is configured to initiate a fingerprint enrollment process to enroll a fingerprint of a user; receive a first enrollment input based on touch data obtained by the fingerprint sensor; process the first enrollment input to extract one or more features corresponding to the fingerprint; determine, based on the first enrollment input, whether to collect a second enrollment input; and based on a determination not to collect a second enrollment input, generate a fingerprint template for the fingerprint. The fingerprint template indicates a set of features extracted from one or more enrollment inputs processed in the fingerprint enrollment process. The one or more enrollment inputs comprise the first enrollment input.

A second aspect of the present disclosure provides a method for fingerprint enrollment. The method includes initiating a fingerprint enrollment process to enroll a fingerprint of a user; receiving a first enrollment input based on touch data obtained by a fingerprint sensor; processing the first enrollment input to extract one or more features corresponding to the fingerprint; determining, based on the first enrollment input, whether to collect a second enrollment input; and based on a determination not to collect a second enrollment input, generating a fingerprint template for the fingerprint. The fingerprint template indicates a set of features extracted from one or more enrollment inputs processed in the fingerprint enrollment process. The one or more enrollment inputs comprise the first enrollment input.

A third aspect of the present disclosure provides non-transitory computer-readable medium, having computer-executable instructions stored thereon for fingerprint enrollment. The computer-executable instructions, when executed, cause one or more processors to perform: initiating a fingerprint enrollment process to enroll a fingerprint of a user; receiving a first enrollment input based on touch data obtained by a fingerprint sensor; processing the first enrollment input to extract one or more features corresponding to the fingerprint; determining, based on the first enrollment input, whether to collect a second enrollment input; and based on a determination not to collect a second enrollment input, generating a fingerprint template for the fingerprint. The fingerprint template indicates a set of features extracted from one or more enrollment inputs processed in the fingerprint enrollment process. The one or more enrollment inputs comprise the first enrollment input.

### BRIEF DESCRIPTION OF THE DRAWINGS

For a more detailed understanding of exemplary features of the present disclosure, the appended drawings are provided for illustration purposes. It will be appreciated, however, that the appended drawings illustrate only exemplary embodiments, and are not intended to limit the scope of the claimed subject matter.

FIG. 1 is a block diagram of an example input device, according to one or more embodiments.

FIG. 2 is a schematic of a further input device, according to one or more embodiments.

FIG. 3 is a chart illustrating the relationship between identification performance and the number of valid touches forced per enrollment, according to an embodiment.

FIG. 4 is a flow diagram illustrating a biometric enrollment pipeline, according to one or more embodiments.

FIG. 5 is a flow diagram of a state machine, according to one or more embodiments.

FIG. 6A is a flowchart illustrating a method for fingerprint enrollment, in accordance with embodiments described herein.

FIG. 6B illustrates the evaluation process using a neural network engine as depicted in FIG. 6A, according to one or more embodiments.

To facilitate understanding, identical reference numerals have been used, where possible, to designate identical elements that are common to the figures. It is contemplated that elements disclosed in one embodiment may be beneficially utilized on other embodiments without specific recitation.

### DESCRIPTION

The following detailed description is exemplary in nature and is not intended to limit the disclosure or the application and uses of the methods and systems described herein. Furthermore, there is no intention to be bound by any expressed or implied theory presented in the preceding technical field, background, summary and brief description of the drawings, or the following detailed description.

In the following description, numerous specific details are set forth such as examples of specific components, circuits, and processes to provide a thorough understanding of the present disclosure. The term “coupled” as used herein means connected directly to or connected through one or more intervening components or circuits. The terms “electronic system” and “electronic device” may be used interchangeably to refer to any system capable of electronically processing information. Also, in the following description and for purposes of explanation, specific nomenclature is set forth to provide a thorough understanding of the aspects of the disclosure. However, it will be apparent to one skilled in the art that these specific details may not be required to practice the example embodiments. In other instances, well-known circuits and devices are shown in block diagram form to avoid obscuring the present disclosure. Some portions of the detailed descriptions which follow are presented in terms of procedures, logic blocks, processing and other symbolic representations of operations on data bits within a computer memory.

In the present disclosure, a procedure, logic block, process, or the like, may refer to a self-consistent sequence of steps or instructions leading to a desired result. Steps may require physical manipulations of physical quantities. Usually, although not necessarily, these quantities take the form of electrical or magnetic signals capable of being stored, transferred, combined, compared, and otherwise manipulated in a computer system. It will be appreciated, however, that all of these and similar terms are to be associated with the appropriate physical quantities and are merely convenient labels applied to these quantities.

Unless specifically stated otherwise or unless it would be understood otherwise from context, terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like refer to the actions and processes of a computer system or similar electronic computing device. The computer system or similar electronic computing device may manipulate and transform data represented as physical (electronic) quantities within the computer system's memories or registers or other such information storage into other data similarly represented as physical quantities within the computer system memories or registers or other such information storage.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described below generally in terms of their functionality. Whether such functionality is implemented as hardware or software depends upon the particular application and design constraints imposed on the overall system. It will be appreciated that the described functionality may be implemented in varying ways for each particular application, but such implementation decisions should not be interpreted as causing a departure from the scope of the present invention. Also, the example input devices may include components other than those shown, including well-known components such as a processor, a memory, and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium including instructions that, when executed, causes performance of one or more of the methods described herein. The non-transitory processor-readable storage medium may form part of a computer program product, which may include packaging materials.

The non-transitory processor-readable storage medium may comprise random access memory (RAM) such as synchronous dynamic random-access memory (SDRAM), read only memory (ROM), non-volatile random-access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments discussed herein may be executed by one or more processors (or a processing system). The term “processor,” as used herein may refer to any general-purpose processor, special-purpose processor, controller, microcontroller, and/or state machine capable of executing scripts or instructions of one or more software programs stored in memory.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Exemplary systems and methods discussed herein provide a dynamic termination mechanism, which is utilized in biometric enrollments and adjusts the number of required biometric inputs based on real-time data. According to exemplary embodiments, a neural network is trained to evaluate the collected biometric input data and to determine sufficient data has been collected for each user's unique conditions. The biometric enrollment process can be terminated based on the evaluation results provided by the neural network, enhancing the user experience by eliminating unnecessary interactions while ensuring consistent and accurate identification performance.

According to exemplary embodiments, the dynamic termination mechanism is integrated into the fingerprint enrollment process. In conventional approaches, the fingerprint enrollment process may consider factors such as finger size, dominant versus non-dominant hand usage, and variations in user touch patterns. In contrast, by leveraging a neural network, the system provided in the present disclosure dynamically analyzes both spatial data (e.g., fingerprint image quality and coverage) and temporal relationships between touches (e.g., changes in angle or connection patterns). This method shortens the time required for users to register their fingerprints, for example, by reducing redundant interactions during the enrollment process. This, in turn, enhances the overall user experience. Furthermore, a trained neural network is used to evaluate the collected data and make enrollment termination decisions. The neural network is trained to ensure that the enrollment termination decisions do not compromise identification performance (e.g., using the enrolled biometric information to identify a specific user), thereby preserving the system's reliability. Additionally, the neural network architecture adapts dynamically to user-specific factors, providing a personalized enrollment experience that accounts for individual differences.

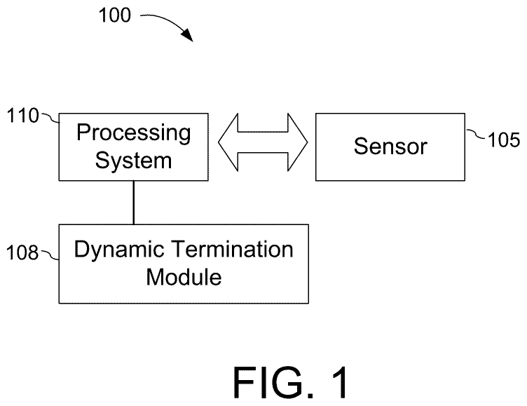

FIG. 1 is a block diagram depicting an example input device 100. The input device 100 may be configured to provide input to an electronic system. As used in this document, the term “electronic system” (or “electronic device”) broadly refers to any system capable of electronically processing information. Some non-limiting examples of electronic systems include personal computers of all sizes and shapes, such as desktop computers, laptop computers, netbook computers, tablets, web browsers, e-book readers, personal digital assistants (PDAs), and wearable computers (such as smart watches and activity tracker devices). Additional examples of electronic systems include composite input devices, such as physical keyboards that include input device 100 and separate joysticks or key switches. Further examples of electronic systems include peripherals such as data input devices (including remote controls and mice), and data output devices (including display screens and printers). Other examples include remote terminals, kiosks, and video game machines (e.g., video game consoles, portable gaming devices, and the like). Other examples include communication devices (including cellular phones, such as smart phones), and media devices (including recorders, editors, and players such as televisions, set-top boxes, music players, digital photo frames, and digital cameras). Additionally, the electronic system may be a host or a peripheral to the input device.

The input device 100 can be implemented as a physical part of the electronic system, or can be physically separate from the electronic system. As appropriate, the input device 100 may communicate with parts of the electronic system using any one or more of the following: buses, networks, and other wired or wireless interconnections. Examples include Inter-Integrated Circuit (I2C), Serial Peripheral Interface (SPI), Personal System/2 (PS/2), Universal Serial Bus (USB), Bluetooth, radio frequency (RF), and Infrared Data Association (IrDA).

In FIG. 1, a biometric device, such as a fingerprint sensor 105, is included with the input device 100. The fingerprint sensor 105 comprises one or more sensing elements configured to sense input provided by one or more input objects in a sensing region. The sensing region encompasses any space on, above, around, in and/or near the fingerprint sensor 105 in which the input device 100 is able to detect user input (e.g., user input provided by one or more input objects). The sizes, shapes, and locations of particular sensing regions may vary from embodiment to embodiment. In some embodiments, the sensing region extends from a surface of the input device 100 in one or more directions into space until signal-to-noise ratios prevent sufficiently accurate object detection. The distance to which this sensing region extends in a particular direction, in various embodiments, may be on the order of less than a millimeter, millimeters, centimeters, or more, and may vary significantly with the accuracy desired. Thus, some embodiments sense input that comprises no contact with any surfaces of the input device 100, contact with an input surface (e.g., a touch surface) of the input device 100, contact with an input surface of the input device 100 coupled with some amount of applied force or pressure, and/or a combination thereof. In various embodiments, input surfaces may be provided by surfaces of sensor substrates within which or on which sensor elements are positioned, or by face sheets or other cover layers positioned over sensor elements.

The input device 100 comprises one or more sensing elements for detecting user input. Some implementations utilize arrays or other regular or irregular patterns of sensing elements to detect the input object. The input device 100 may utilize different combinations of sensor components and sensing technologies to detect user input in the sensing region.

In certain implementations, the input device 100 is a capacitive input device. Voltage or current is applied to create an electric field. Nearby input objects cause changes in the electric field, and produce detectable changes in capacitive coupling that may be detected as changes in voltage, current, or the like.

Some implementations utilize arrays or other regular or irregular patterns of capacitive sensing elements to create electric fields. In some implementations, separate sensing elements may be ohmically shorted together to form larger sensor electrodes. Some implementations utilize resistive sheets, which may be uniformly resistive.

Some implementations utilize “self capacitance” (or “absolute capacitance”) sensing methods based on changes in the capacitive coupling between sensor electrodes and an input object. In various embodiments, an input object near the sensor electrodes alters the electric field near the sensor electrodes, thus changing the measured capacitive coupling. In one implementation, an absolute capacitance sensing method operates by modulating sensor electrodes with respect to a reference voltage (e.g. system ground), and by detecting the capacitive coupling between the sensor electrodes and input objects. In another implementation, an absolute capacitance sensing method operates by modulating a drive ring or other conductive element that is ohmically or capacitively coupled to the input object, and by detecting the resulting capacitive coupling between the sensor electrodes and the input object. The reference voltage may by a substantially constant voltage or a varying voltage and in various embodiments; the reference voltage may be system ground.

Some implementations utilize “mutual capacitance” (or “transcapacitance”) sensing methods based on changes in the capacitive coupling between sensor electrodes. In various embodiments, an input object near the sensor electrodes alters the electric field between the sensor electrodes, thus changing the measured capacitive coupling. In one implementation, a transcapacitive sensing method operates by detecting the capacitive coupling between one or more transmitter sensor electrodes (also “transmitter electrodes” or “drive electrodes”) and one or more receiver sensor electrodes (also “receiver electrodes” or “pickup electrodes”). Transmitter sensor electrodes may be modulated relative to a reference voltage to transmit transmitter signals. Receiver sensor electrodes may be held substantially constant relative to the reference voltage to facilitate receipt of resulting signals. The reference voltage may be, for example, a substantially constant voltage or system ground. In some embodiments, transmitter sensor electrodes and receiver sensor electrodes may both be modulated. The transmitter electrodes are modulated relative to the receiver electrodes to transmit transmitter signals and to facilitate receipt of resulting signals. A resulting signal may comprise effect(s) corresponding to one or more transmitter signals, and/or to one or more sources of environmental interference (e.g. other electromagnetic signals). Sensor electrodes may be dedicated transmitters or receivers, or may be configured to both transmit and receive.

Some implementations of the input device 100 are configured to provide images that span one, two, three, or higher dimensional spaces. The input device 100 may have a sensor resolution that varies from embodiment to embodiment depending on factors such as the scale of information of interest. In some embodiments, the sensor resolution is determined by the physical arrangement of an array of sensing elements, where smaller sensing elements and/or a smaller pitch can be used to define a higher sensor resolution.

As an example, the input device 100 is implemented as a fingerprint sensor device having a sensor resolution high enough to capture discriminative features of a fingerprint. In some implementations, the fingerprint sensor has a resolution sufficient to capture minutia (including ridge endings and bifurcations), orientation fields (sometimes referred to as “ridge flows”), and/or ridge skeletons. These are sometimes referred to as level 1 and level 2 features, and, in an exemplary embodiment, a resolution of at least 250 pixels per inch (ppi) is capable of reliably capturing these features. In some implementations, the fingerprint sensor has a resolution sufficient to capture higher level features, such as sweat pores or edge contours (i.e., shapes of the edges of individual ridges). These are sometimes referred to as level 3 features, and, in an exemplary embodiment, a resolution of at least 750 pixels per inch (ppi) is capable of reliably capturing these higher level features.

In some embodiments, a fingerprint sensor is implemented as a placement sensor (also “area” sensor or “static” sensor) or a swipe sensor (also “slide” sensor or “sweep” sensor). In a placement sensor implementation, the sensor is configured to capture a fingerprint input as the user's finger is held stationary over the sensing region. Typically, the placement sensor includes a two-dimensional array of sensing elements capable of capturing a desired area of the fingerprint in a single frame. In a swipe sensor implementation, the sensor is configured to capture to a fingerprint input based on relative movement between the user's finger and the sensing region. Typically, the swipe sensor includes a linear array or a thin two-dimensional array of sensing elements configured to capture multiple frames as the user's finger is swiped over the sensing region. The multiple frames may then be reconstructed to form an image of the fingerprint corresponding to the fingerprint input. In some implementations, the sensor is configured to capture both placement and swipe inputs.

In some embodiments, a fingerprint sensor is configured to capture less than a full area of a user's fingerprint in a single user input (referred to herein as a “partial” fingerprint sensor). Typically, the resulting partial area of the fingerprint captured by the partial fingerprint sensor is sufficient for the system to perform fingerprint matching from a single user input of the fingerprint (e.g., a single finger placement or a single finger swipe). Some exemplary imaging areas for partial placement sensors include an imaging area of 100 mm² or less. In another exemplary embodiment, a partial placement sensor has an imaging area in the range of 20-50 mm². In some implementations, the partial fingerprint sensor has an input surface that is the same size as the imaging area.

In FIG. 1, a processing system 110 is included with the input device 100. The processing system 110 comprises parts of or all of one or more integrated circuits (ICs) and/or other circuitry components. The processing system 110 is coupled to the fingerprint sensor 105, and is configured to detect input in the sensing region using sensing hardware of the fingerprint sensor 105.

The processing system 110 may include driver circuitry configured to drive sensing signals with sensing hardware of the input device 100 and/or receiver circuitry configured to receive resulting signals with the sensing hardware. For example, a processing system for a mutual capacitance sensor device may be configured to drive transmit signals onto transmitter sensor electrodes of the fingerprint sensor 105, and/or receive resulting signals detected via receiver sensor electrodes of the fingerprint sensor 105. Further, a processing system for a self capacitance sensor device may be configured to drive absolute capacitance signals onto sensor electrodes of the fingerprint sensor 105, and/or receive resulting signals detected via those sensor electrodes of the fingerprint sensor 105.

The processing system 110 may include processor-readable instructions, such as firmware code, software code, and/or the like. The processing system 110 can be integrated with the fingerprint sensor 105 (e.g., the processing system 110 may be a fingerprint sensor chip and the fingerprint sensor 105 may be a capacitive sensor array, both of which are part of a fingerprint sensor package), or can be physically separate from the fingerprint sensor 105. Also, constituent components of the processing system 110 may be located together, or may be located physically separate from each other. For example, the input device 100 may be a peripheral coupled to a computing device, and the processing system 110 may comprise software configured to run on a central processing unit of the computing device and one or more ICs (e.g., with associated firmware) separate from the central processing unit. As another example, the input device 100 may be physically integrated in a mobile device, and the processing system 110 may comprise circuits and firmware that are part of a main processor of the mobile device. The processing system 110 may be dedicated to implementing the input device 100, or may perform other functions, such as operating display screens, driving haptic actuators, etc.

The processing system 110 may operate the sensing element(s) of the fingerprint sensor 105 of the input device 100 to produce electrical signals indicative of input (or lack of input) in a sensing region. The processing system 110 may perform any appropriate amount of processing on the electrical signals in producing the information provided to the electronic system. For example, the processing system 110 may digitize analog electrical signals obtained from the sensor electrodes. As another example, the processing system 110 may perform filtering or other signal conditioning. As yet another example, the processing system 110 may subtract or otherwise account for a baseline, such that the information reflects a difference between the electrical signals and the baseline. As yet further examples, the processing system 110 may determine positional information, recognize inputs as commands, recognize handwriting, match biometric samples, and the like.

The electronic system may include a display device. The display device may be any suitable type of dynamic display capable of displaying a visual interface to a user, including an inorganic light-emitting diode (LED) display, organic LED (OLED) display, cathode ray tube (CRT), liquid crystal display (LCD), plasma display, electroluminescence (EL) display, or other display technology. The display may be flexible or rigid, and may be flat, curved, or have other geometries. The display may include a glass or plastic substrate for thin-film transistor (TFT) circuitry, which may be used to address display pixels for providing visual information and/or providing other functionality. The display device may include a cover lens (sometimes referred to as a “cover glass”) disposed above display circuitry and above inner layers of the display module, and the cover lens may also provide an input surface for the input device 100. Examples of cover lens materials include optically clear amorphous solids, such as chemically hardened glass, and optically clear crystalline structures, such as sapphire. The input device 100 and the display device may share physical elements. For example, the display screen may be operated in part or in total by the processing system 110 in communication with the display screen.

In one or more embodiments, the processing system 110 further is connected to a dynamic termination module 108. The dynamic termination module 108 can be implemented as software, hardware, or a combination thereof. The dynamic termination module 108 can be integrated into the processing system 110 or operate as a separate module connected to the processing system 110, for example, to receive input data from the processing system 110.

In one or more embodiments, the dynamic termination module 108 incorporates a neural network. A neural network is a computational model composed of a series of interconnected layers, each containing multiple nodes (or neurons). These nodes are designed to process and transform input data by applying weights and activation functions. The layers include one or more input layers, hidden layers, and output layers. The input layer(s) receives data, which is processed by the hidden layer(s), and the output layer(s) produces the final result or prediction. The network is trained using algorithms (e.g., backpropagation) to adjust the weights and optimize performance.

Various neural network architectures can be used, in accordance with embodiments described herein. In one or more embodiments, the Recurrent Neural Network (RNN) architecture is used to process sequential data. For example, one or more Gated Recurrent Units (GRUs) are utilized to capture long-term dependencies in sequences while mitigating the vanishing gradient problem. In one or more embodiments, Fully Connected (FC) layers are used for high-level feature extraction and classification. For example, FC layers are used to process the extracted features as input and output a binary classification. However, it will be noted that other types of machine learning algorithms or neural network models can also be applied to classify whether additional input data are needed.

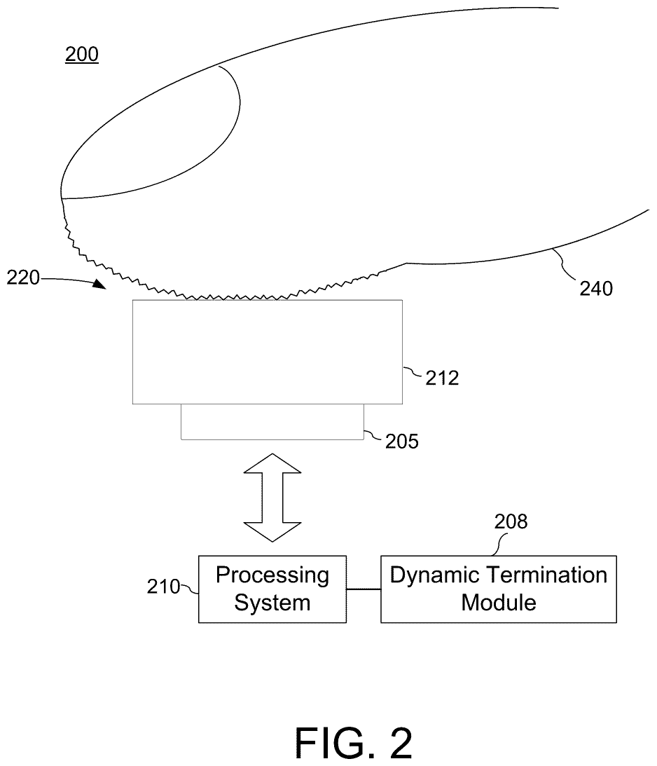

FIG. 2 is a block diagram depicting a further exemplary input device 200. In FIG. 2, the input device 200 is shown as including a fingerprint sensor 205. The fingerprint sensor 205 is configured to capture a fingerprint from a finger 240. The fingerprint sensor 205 is disposed underneath a cover layer 212 that provides an input surface for the fingerprint to be placed on or swiped over the fingerprint sensor 205. The sensing region 220 may include an input surface with an area larger than, smaller than, or similar in size to a full fingerprint. The fingerprint sensor 205 has an array of sensing elements with a resolution configured to detect surface variations of the finger 240. The fingerprint sensor 205 is connected to a processing system 210, which drives the fingerprint sensor 205 and processes signals detected by the fingerprint sensor 205. The dynamic termination module 208 is connected to the processing system 210, which evaluates fingerprint enrollment processes in real-time to dynamically determine when to terminate enrollment.

While the input device is generally described in the context of a fingerprint sensor, embodiments include other biometric sensor devices. In various embodiments, a biometric sensor device may be configured to capture physiological biometric characteristics of a user. Some example physiological biometric characteristics include fingerprint patterns, vascular patterns (sometimes known as “vein patterns”), palm prints, hand geometry, and facial patterns. Further, although the fingerprint sensor is described in the context of a capacitive sensor, the methods and systems herein apply equally to optical, ultrasonic, acoustical as well as other technologies.

In one or more embodiments, the input device 100 as shown in FIG. 1 (or the input device 200 as shown in FIG. 2) is used to perform a fingerprint enrollment process, which involves capturing and storing a user's fingerprint data for authentication purposes. For example, the input device 100 captures fingerprint data (e.g., obtain one or more images that record ridge patterns of the user), processes the fingerprint data (e.g., extracting key features), creates a fingerprint template (e.g., generating representations for the identified features corresponding to the fingerprint), and stores the fingerprint template in a database (e.g., local or cloud-based) or on a local device (e.g., the input device 100) for future authentication. In one or more embodiments, the input device 100 prompts the user to enroll their fingerprint through multiple valid touches to ensure accuracy and consistency. This process ensures that the fingerprint data can be reliably used for future identification or authentication.

For fingerprint-based biometric authentication systems, achieving a high-quality enrollment process is critical for optimal identification performance. A “good enrollment” is defined based on various factors, such as fingerprint coverage and image quality. In conventional products, the enrollment process focuses on maximizing the fingerprint coverage and ensuring the quality of collected data. Typically, these systems require users to provide a predetermined number of valid touches to complete the enrollment process. The number of required touches is typically set to balance fingerprint identification performance and user experience, which may vary across different products. One key evaluation metric is False Rejection Rate (FRR), which measures the probability of incorrectly rejecting a valid user. FRR is defined as the percentage of genuine authentication attempts that are mistakenly denied by an authentication system.

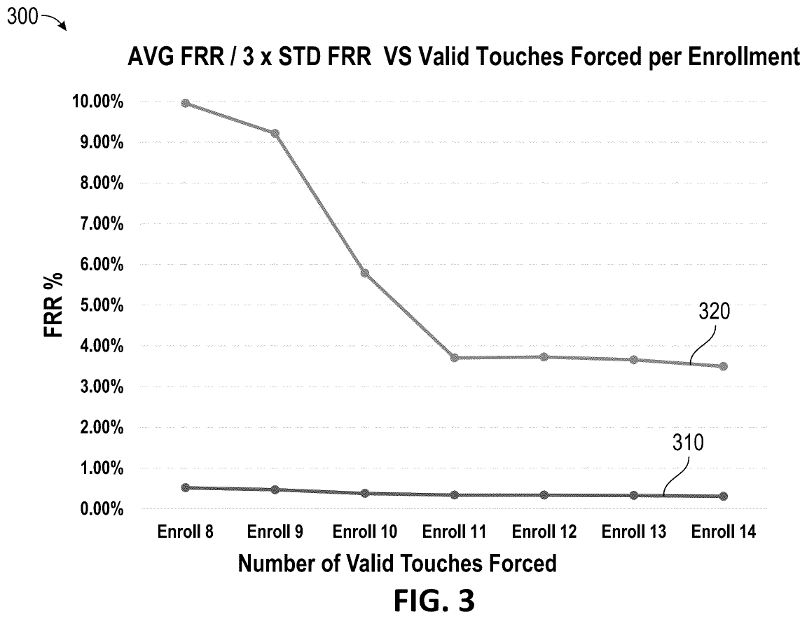

FIG. 3 is a chart 300 illustrating the relationship between identification performance, measured by FRR, and the number of valid touches forced per enrollment, according to an embodiment. In this example, a group of users enrolled their fingerprints with varying numbers of valid touches forced per enrollment and then performed identification using their enrolled fingerprint data. FRRs were calculated across users for different numbers of valid touches forced per enrollment. The statistical distribution of FRRs across users is illustrated in FIG. 3.

In this example, curve 310 (and its associated points) represents the average (or mean) FRR across users at different numbers of valid touches forced per enrollment, while curve 320 represents three times (3×) the standard deviation (STD) of FRR across users at different numbers of valid touches forced per enrollment. The mean FRR indicates the general performance of the authentication system in terms of false rejections across users. The STD measures the spread or variability of the FRR values across users. A 3×STD is a threshold that covers most of the data points in a normal distribution (approximately 99.7% of the data points fall within ±3 standard deviations from the mean). In other words, a 3×STD shows the range within which most users' FRR values fall. It indicates how much variability there is in the FRR performance across the user group. A large 3×STD suggests that the system's performance varies significantly among users, while a small 3×STD indicates more consistent performance.

As shown in FIG. 3, while collecting more valid touches during the enrollment process can reduce the average FRR, this reduction is often minimal. In contrast, the STD of FRR across individual users' fingerprints tends to decrease more significantly with additional touches, reflecting improved consistency. However, FIG. 3 also indicates that not all users or conditions benefit equally from additional touches. Some users achieve optimal enrollment with fewer touches, while others may require more to reach similar performance levels. For example, differences in user behavior and interaction habits with the product (e.g., the input device 100) may impact the number of valid touches required for different users. As such, forcing a fixed number of valid touches for all users could lead to inefficiencies, unnecessary redundancy, and a suboptimal user experience, particularly for those who do not need the extra steps. Therefore, achieving consistent identification performance across diverse users is a challenge, when a fixed number of valid touches is required per enrollment, without compromising the user experience.

The present disclosure incorporates a trained neural network (NN) model, referred to as a neural network engine, into a biometric enrollment pipeline to enable dynamic termination by evaluating real-time data collected from the user. In certain embodiments, systems and methods for the fingerprint enrollment process are provided as examples to facilitate understanding of the core principles of the present disclosure but are not intended to limit the scope of the disclosure.

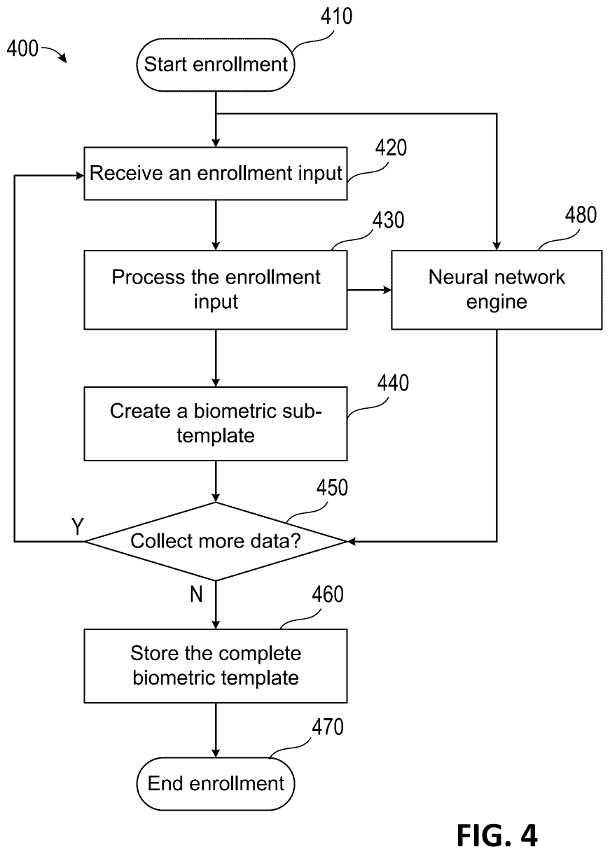

FIG. 4 is a flow diagram illustrating a biometric enrollment pipeline 400, according to one or more embodiments. The biometric enrollment pipeline 400 can be applied to various biometric enrollment processes, including fingerprint, facial, iris, retina, hand/palm, among other biometric modalities, where both spatial and temporal data can be utilized. A biometric enrollment process involves iterative steps to sequentially capture, analyze, and process input data for creating a unique biometric profile (e.g., a biometric template). For example, in a fingerprint enrollment process, the processing system 110 (e.g., in the input device 100) prompts the user to place their finger on the fingerprint sensor 105, guiding the user to position the finger correctly for a valid scan (or a valid touch). After each scan, the user is instructed to adjust their finger for additional scans to capture sufficient data.

The biometric enrollment pipeline 400 may be performed by the processing system 110 within the input device 100. For example, one or more processors in the processing system 110 may execute computer-executable instructions based on stored firmware and/or software code to carry out some or all of the blocks in biometric enrollment pipeline 400 in any suitable order. However, it will be understood that biometric enrollment pipeline 400 may be facilitated by various suitable hardware and/or software components.

In FIG. 4, blocks 410-470 represent the general stages of a biometric enrollment, while neural network engine 480 and its associated arrows illustrate interventions introduced by the neural network engine 480 at multiple stages of the biometric enrollment pipeline 400.

At stage 410, the processing system 110 starts a biometric enrollment. For example, upon receiving an instruction to start fingerprint enrollment, the processing system 110 initiates the enrollment process for a specific fingerprint of a user. In one or more embodiments, the neural network engine 480 is initialized when the enrollment is initiated.

In one or more embodiments, during initialization, an enrollment counter is set to 0. The enrollment counter is used to track the number of enrollment inputs that have been processed (e.g., the touches by the user). In one or more embodiments, an initial state of the neural network engine 480 is set to t=0. The enrollment counter is linked to the state of the neural network engine 480, as processing a valid input causes the neural network engine 480 to transition into a next state.

At stage 420, the processing system 110 receives an enrollment input. For example, at each iteration, the processing system 110 instructs the user to scan their finger in a specified pose (e.g., position and/or rotation). The processing system 110 obtains a fingerprint image, as an enrollment input, by scanning the user's finger using the fingerprint sensor 105.

At stage 430, the processing system 110 processes the enrollment input.

In one or more embodiments, the processing system 110 first filters out invalid enrollment inputs, such as duplicates or poor-quality data. For example, in the context of fingerprint enrollment, the processing system 110 first determines valid touches for further processing. If an invalid input is detected, the processing system 110 returns to stage 420 to recollect data. In one or more embodiments, the processing system 110 may decide to accept an invalid enrollment input for further processing if the number of consecutive failed inputs during the screening phase exceeds a predefined threshold.

For valid inputs, the processing system 110 extracts features from the enrollment input. The features include spatial and/or temporal features. Spatial features represent local characteristics captured in the current input data, while temporal features reflect connections between various inputs. In one or more embodiments, the temporal features, such as the connections, represent transformations, overlap areas, and angles of variation between the current input and the prior input(s).

The neural network engine 480 receives an input formed based on the features extracted from the enrollment data, including the current enrollment input and the previous enrollment input(s). For example, spatial features from each enrollment input are extracted and stored in a designated memory space. Temporal features are derived by comparing the spatial features from the current enrollment input with the spatial features from one or more prior enrollment inputs. In one or more embodiments, the temporal features are derived from comparisons between the current enrollment input (at time t) and each of the following: the prior enrollment inputs at t−1, t−2, t=0, and t=1, respectively. The enrollment inputs at t=0 and t=1 correspond to the first and second enrollment inputs that have been successfully processed in the biometric enrollment pipeline 400. In one or more embodiments, the spatial features from the current enrollment input (at time t) are compared to the spatial features from prior enrollment inputs at t−1, t−2, and t−3 to derive the corresponding temporal features. In this example, when t<3, certain temporal features can be set to a default value, as previous enrollment data may be unavailable. As such, the neural network engine 480 evaluates each valid enrollment input with an evolving understanding, incorporating insights from previously collected data. In one or more embodiments, the neural network engine 480 generates an output indicating whether further data is needed.

At stage 440, the processing system 110 creates a biometric sub-template corresponding to a valid enrollment input. For example, the processing system 110 generates a biometric sub-template (or, for short, sub-template) to represent the features extracted from stage 430. A sub-template includes representations of one or more features identified in from the current enrollment input. A complete biometric template is formed by combining the features from one or more sub-templates.

In one or more embodiments, certain features (spatial and/or temporal) extracted from the enrollment data can be represented by one or more descriptors. Descriptors may be represented as feature vectors, binary codes, matrices, embedding vectors, multidimensional arrays, or other suitable formats. In fingerprints, descriptors can be used to represent key points (e.g., minutiae points), ridge flow, pattern-based features (e.g., overall ridge patterns), the frequency and orientation of the ridges, among other things. The sub-templates may include one or more descriptors to represent the identified features.

At stage 450, the processing system 110 determines whether to collect additional data. The processing system 110 proceeds to stage 420 if additional data needs to be collected. In this case, the enrollment counter is incremented by one. Alternatively, if no further data is required, the system proceeds to stage 460.

In certain methods, a predefined maximum number of enrollments (or enrollment inputs) is used to determine the termination condition of the enrollment process. In other words, the authentication system continues data collection and processing until the predefined number of valid enrollments is reached. As discussed earlier, this approach may not be necessary for all users.

As shown in FIG. 4, the neural network engine 480 is used to determine, based on features extracted from stage 430, whether the enrollment process should be terminated earlier than the standard procedure (e.g., reaching the predefined maximum number of valid enrollments). In one or more embodiments, the neural network engine 480 evaluates spatial and/or temporal features associated with the current enrollment input, which, for example, represent connections between the current enrollment input and one or more previous enrollment inputs. These insights allow the processing system to make data-driven decisions on whether the enrollment process can be terminated early, ensuring robust identification performance without requiring unnecessary touches. The neural network engine 480 generates an output to indicate whether to trigger an earlier termination. In one or more embodiments, the output includes a binary classification, indicating one of two possible outcomes, such as, for example, “Require More Touches” or “No More Touches Needed.”

At stage 460, the processing system 110 stores a finalized or complete biometric template for the enrolled biometric information. For example, the processing system 110 combines the sub-templates from multiple enrollment inputs to generate a complete biometric template.

At stage 470, the processing system 110 ends the enrollment. Of course, the procedure of biometric enrollment pipeline 400 may be repeated any suitable number of times to collect additional biometric information, e.g., data for a fingerprint from another finger.

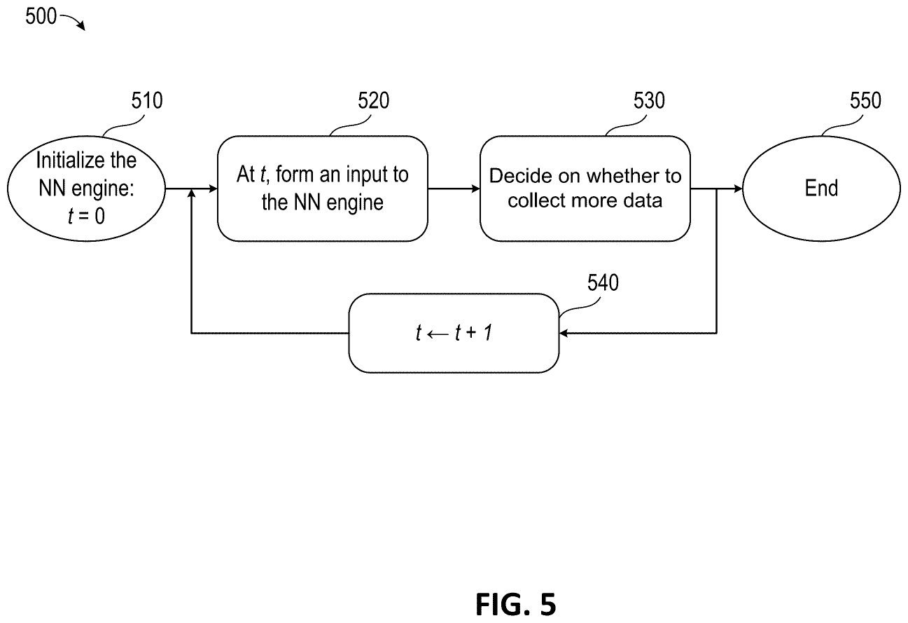

FIG. 5 is a flow diagram of a state machine 500, according to one or more embodiments. In some implementations of the present invention, the neural network engine 480 as shown in FIG. 4 can be embodied in (in whole or in part) or otherwise integrated into the state machine 500.

The state machine 500 may be performed by the processing system 110 within the input device 100. For example, one or more processors in the processing system 110 may execute computer-executable instructions based on stored firmware and/or software code to carry out some or all of the blocks in state machine 500 in any suitable order. However, it will be understood that state machine 500 may be facilitated by various suitable hardware and/or software components.

At stage 510, the neural network engine 480 is initialized as t=0, where t is a state indicator. For example, the initialization of the neural network engine 480 can be performed when the processing system 110 initiates the biometric enrollment process at stage 410.

At stage 520, an input to the neural network engine 480 is formed at the state t. The input is formed based on features, such as spatial and/or temporal features, extracted from the current enrollment input and one or more previous enrollment input(s). At stage 530, the neural network engine 480 processes the input and determines whether further data collection is needed.

At stage 540, the state indicator is incremented by one, indicating that the state machine 500 has transitioned to the new state. The state machine 500 at the state t+1 is used to process the next round of input derived from the subsequent enrollment input.

At stage 550, the state machine 500 ends, for example, when the enrollment process is completed.

However, it will be understood that the neural network engine 480 can be integrated into the biometric enrollment pipeline using other suitable methods, apart from the state machine.

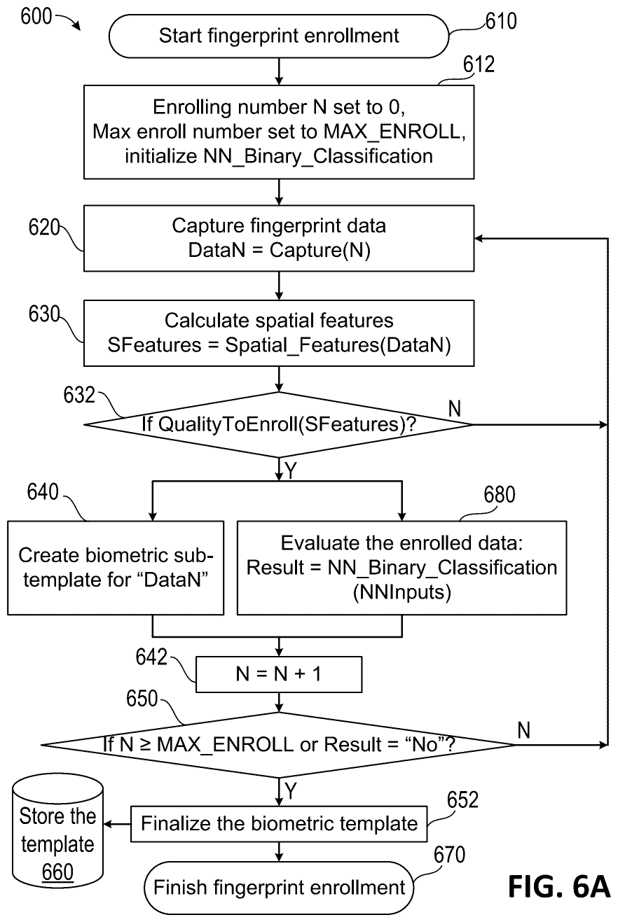

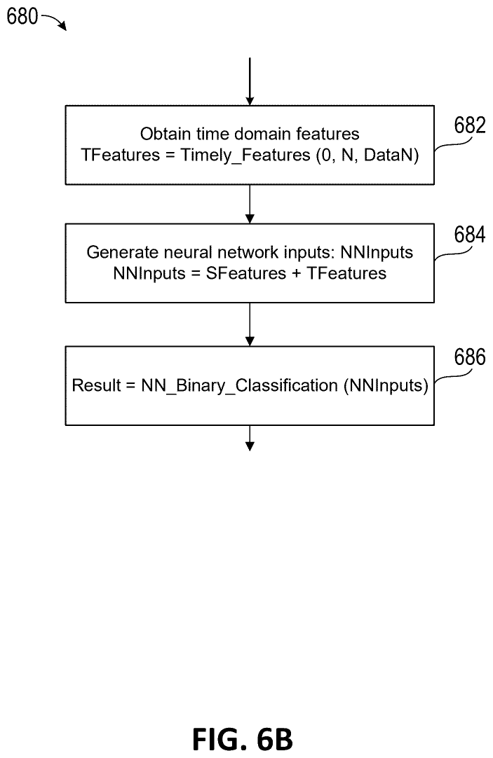

FIG. 6A is a flowchart illustrating a method 600 for fingerprint enrollment, in accordance with embodiments described herein. It will be understood that the method 600 need not be performed in the order shown, and stages may be concurrently or simultaneously performed, except where otherwise apparent.

The method 600 may be performed by the processing system 110 within the input device 100. For example, one or more processors in the processing system 110 may execute computer-executable instructions based on stored firmware and/or software code to carry out some or all of the blocks in method 600 in any suitable order. However, it will be understood that method 600 may be facilitated by various suitable hardware and/or software components.

At stage 610, the processing system 110 starts a fingerprint enrollment process.

At stage 612, the processing system 110 initializes the enrollment process. In one or more embodiments, the processing system 110 initializes an enrollment counter, represented by N, to zero. This counter tracks the number of enrollment inputs processed, such as the number of valid touches processed to generate one or more biometric sub-templates. In one or more embodiments, the processing system 110 sets a maximum enrollment number, represented by MAX_ENROLL, which defines the upper limit of enrollment inputs to be processed in the enrollment process. This ensures, for example, that the process does not exceed the memory capacity. In one or more embodiments, the processing system 110 initializes a neural network engine, represented by NN_Binary_Classification, to prepare for receiving the first input. For example, the neural network engine can be embodied in (in whole or in part) or otherwise integrated into a state machine, as illustrated in FIG. 5, where the neural network engine is set to an initial state: t=0 at stage 510.

At stage 620, the processing system 110 captures fingerprint data as the current enrollment input. In one or more embodiments, the processing system 110 obtains a fingerprint image from the captured fingerprint data. The fingerprint data, such as the fingerprint image, is denoted as DataN, and the data collection process can be expressed as: DataN=Capture(N).

At stage 630, the processing system 110 calculates a number of spatial features from the captured data. The spatial feature extraction is represented as SFeatures=Spatial_Features (DataN), where SFeatures denotes the spatial features.

The processing system 110 extracts various spatial and/or temporal features for each enrollment input obtained from stage 620. The spatial features represent local characteristics captured in the current enrollment input, while the temporal features represent the relationship between sequential data (e.g., successive touches), including connections between the current touch and prior touches, as well as transformations, overlap areas, angles of variation, etc.

In one or more embodiments, the processing system 110 extracts a subset of features at this stage for evaluating the validity of the current enrollment input at stage 632, and then extracts additional features at another stage (e.g., stage 680) for further evaluation. Alternatively, the processing system 110 extracts all spatial and temporal features at this stage and uses different sets of features at subsequent stages.

The extracted features may include various types, including the ones discussed earlier represent the fingerprint, as well as additional features. For example, the features further include an image quality feature, a redundancy detection feature, a spatial and temporal relationships feature, and a coverage metrics feature. The image quality feature represents the quality of the current fingerprint image, including aspects such as clarity and resolution. The redundancy detection feature indicates the degree of duplication with previous touches. For example, the redundancy detection feature may be determined by identifying repeated or unnecessary data in the fingerprint image. The spatial and temporal relationships feature represents changes and/or connections in the sequentially obtained fingerprint data, for example, by analyzing spatial aspects, such as ridge patterns, and temporal aspects, like changes over time in the fingerprint capture, such as variations in angle or pressure applied. In one or more embodiments, the spatial and temporal relationship feature is extracted based on the current enrollment input and some or all of the previously collected enrollment data. This feature may be used to generate a fingerprint template (or a sub-template). The coverage metrics feature represents the cumulative fingerprint coverage and the quality of overlap with previous touches, for example, by assessing how much of the fingerprint is captured during the enrollment process.

At this stage or a later stage (e.g., stage 680 in FIG. 6A or stage 682 in FIG. 6B), the processing system 110 further exacts time temporal features for the current enrollment. For example, the processing system 110 may proceed to calculate the temporal features when determining that the current enrollment is valid at stage 632.

At stage 632, the processing system 110 determines, based on the spatial features obtained from stage 630, whether the current enrollment input is qualified for further processing. The evaluation process is represented as: QualityToEnroll(SFeatures).

When determining that the current enrollment input is not qualified, the processing system 110 returns to stage 620, instructing the user to recollect the enrollment input. In this case, the enrolling counter (N) remains unchanged.

When determining that the current enrollment input is qualified, the processing system 110 proceeds to perform processing as indicated in stages 640 and 680, which stages may be performed in parallel in certain embodiments.

At stage 640, the processing system 110 creates a biometric sub-template for the current enrollment input. The biometric sub-template provides a partial set of information that contributes to the complete biometric template. For example, during fingerprint enrollment, a set of key features associated with the enrolled fingerprint is identified. These key features are then used to authenticate the user during future attempts. The key features are extracted from the fingerprint and recorded in a predefined format, often referred to as a biometric template. This biometric template serves as a compact representation of the user's unique fingerprint characteristics.

The biometric sub-template includes representations and/or descriptions of one or more key features from the complete set of features that will eventually make up the full biometric template. For example, each biometric sub-template may include details about specific minutiae points such as ridge endings or bifurcations, as well as their locations and orientations. One or more biometric sub-templates are used to create the complete biometric template, which stores essential fingerprint characteristics needed to accurately identify the user.

At stage 680, the processing system 110 evaluates the enrollment data using the neural network engine (NN_Binary_Classification) and outputs a result indicating whether further data is needed in the enrollment process. Further details in this stage will be elaborated hereafter with reference to FIG. 6B.

At stage 642, the processing system 110 increments the enrollment counter. For example, N=N+1, which indicates that one enrollment input has been successfully processed.

At stage 650, the processing system 110 evaluates the termination condition for the enrollment process. For example, the processing system 110 determines if N≥MAX_ENROLL by comparing the enrollment counter (N) with the preset maximum value (MAX_ENROLL). Additionally, the processing system 110 considers the result from the neural network engine (NN_Binary_Classification), for example, if the result indicates that no further data is needed.

When neither of the aforementioned conditions is true, the processing system 110 returns to stage 620 to obtain the next enrollment input.

When at least one of the aforementioned conditions is true, the processing system 110 exits the loop and proceeds to stage 652.

At stage 652, the processing system 110 finalizes the biometric template. For example, the processing system 110 combines the one or more biometric sub-templates obtained from one or more enrollment inputs.

At stage 660, the processing system 110 stores the finalized biometric template.

The biometric template can be stored in various forms, such as structured tables, metadata, or other formats designed to capture and organize the relevant features. For example, it may include tables that list the locations, minutiae, and orientations of ridge endings and bifurcations in the fingerprint. Alternatively, the template could be represented as metadata, which contains information about the fingerprint's key features, such as its quality, resolution, and other attributes, alongside the raw data needed for comparison during later authentication processes. These templates enable efficient and accurate user identification while ensuring secure and reliable enrollment data management.

In one or more embodiments, the biometric template may include descriptors that provide further details about the fingerprint's characteristics. For example, the biometric template incorporates descriptors indicating the overall fingerprint pattern type (e.g., arch, loop, or whorl), the level of minutiae detail, or the degree of distortion due to pressure or angle. These descriptors help enhance the template's ability to identify the user under various conditions, making it a more robust and flexible tool for biometric authentication.

At stage 670, the processing system 110 ends the fingerprint enrollment process.

FIG. 6B illustrates the evaluation process of stage 680 using the neural network engine as depicted in FIG. 6A, according to one or more embodiments. It will be understood that the evaluation process of stage 680 need not be performed in the order shown, and stages may be concurrently or simultaneously performed, except where otherwise apparent.

The evaluation process of stage 680 may be performed by the processing system 110 within the input device 100. For example, one or more processors in the processing system 110 may execute computer-executable instructions based on stored firmware and/or software code to carry out some or all of the blocks in the evaluation process of stage 680 in any suitable order. However, it will be understood that the evaluation process of stage 680 may be facilitated by various suitable hardware and/or software components.

At stage 682, the processing system 110 obtains time domain features (or temporal features). As discussed above, the processing system 110 extracts various temporal features based on the current enrollment input and prior enrollment input(s). This feature extraction process can be performed at this stage or one or more prior stages in the method 600.

In one or more embodiments, the temporal feature extraction process is expressed as: TFeatures=Timely_Features(0, N, DataN). For example, the temporal features are derived from comparisons between the current enrollment input (at time t) and each of the following: the prior enrollment inputs at t−1, t−2, t=0, and t=1, respectively. The enrollment inputs at t=0 and t=1 correspond to the first and second enrollment inputs that have been successfully processed in the enrollment process. In one or more embodiments, the temporal feature extraction process is expressed as: TFeatures=Timely_Features (N−3, N, DataN). In this example, the temporal features are extracted based on the current enrollment input and up to three prior consecutive enrollment inputs. Of course, any suitable number of prior inputs may be used. In this case, the processing system 110 may use default values when N−i<0, where i is an integer, to form the input to the neural network engine. In certain embodiments, the processing system 110 obtains temporal features based on the current enrollment input and all prior enrollment inputs.

At stage 684, the processing system 110 generates one or more inputs to the neural network engine. The process is expressed as: NNInputs=SFeatures+TFeatures, where NNInputs represents the inputs to the neural network engine. For example, the processing system 110 concatenates the spatial features and the temporal features associated with the current enrollment input to form the input(s) to the neural network engine.

At stage 686, the processing system 110 feeds the input(s) from stage 684 to the neural network engine and outputs an evaluation result using the neural network engine. This process is expressed as: Result=NN_Binary_Classification (NNInputs). In one or more embodiments, the result is a binary classification. For example, one outcome can be “Require More Touches,” which indicates enrollment must continue to improve template quality. The other outcome can be “No More Touches Needed,” which indicates that the enrollment process can be terminated as the data is sufficient.

The processing system 110 considers the result from stage 686 when evaluating the termination condition for the enrollment at stage 650 as illustrated in FIG. 6A.

In one or more embodiments, the processing system 110 may update the state of the state machine upon completing an iteration of stage 680. For example, as illustrated in FIG. 5, at stage 540, the state indicator may be updated as follows: t←t+1.

In one or more embodiments, the neural network engine and/or the corresponding processes (e.g., described in stage 680) can be adapted to improve other aspects of fingerprint systems, such as identifying spoof fingerprints during enrollment. For example, by linking spatial and temporal data features with spoof detection mechanisms, the same framework can prevent unauthorized access during enrollment.

In one or more embodiments, a neural network model for dynamic fingerprint enrollment is trained using a dataset that includes fingerprint data collected from multiple users under various environmental and finger conditions. For example, data may be gathered under different temperature settings (high, normal, and low), and under various finger conditions, including dry, wet, dirty, and normal states. In one example, for each unique combination of the environmental and finger conditions, a set of (e.g., 25) fingerprint registration images and a set of (e.g., 60) recognition images may be collected per finger. Using the dataset, False Rejection Rate (FRR) performance can be evaluated under different enrollment scenarios. The minimum number of valid touches required to maintain a consistent FRR can be determined for each condition to use as baseline for defining the termination criteria for enrollment.

The neural network model is trained to predict an output indicating whether further data is needed for each enrollment process. The weights of the model are updated by evaluating the prediction against a ground truth, which may be, for example, derived based on the baseline.

Table 1 shows comparative analysis between fixed-touch enrollment systems and a dynamic system provided in the present disclosure.

TABLE 1
Comparative Analysis Across Systems.

| | Enroll | Enroll | Enroll | Enroll | Enroll | Enroll | Enroll | Enroll with |
|---|---|---|---|---|---|---|---|---|
| | 8 | 9 | 10 | 11 | 12 | 13 | 14 | NN model |
| Average FRR | 0.51% | 0.46% | 0.37% | 0.33% | 0.33% | 0.32% | 0.30% | 0.32% |
| Mean FRR and 3× | 9.95% | 9.21% | 5.78% | 3.70% | 3.72% | 3.65% | 3.49% | 4.07% |
| per finger FRR | | | | | | | | |
| STD | | | | | | | | |
| Average valid | 8 | 9 | 10 | 11 | 12 | 13 | 14 | 8.3502 |
| touches required | | | | | | | | |

Table 1 shows that the dynamic system provided in the present disclosure offers multiple benefits, including a significant reduction in the number of valid touches required for most users, consistent FRR performance with minimal variation across users, and an enhanced user experience by reducing redundant interactions during enrollment.

In one or more embodiments, part of the dynamic termination process discussed above may be achieved through a set of heuristics and algorithms based on pre-defined rules. For example, spatial and temporal data from fingerprint touches (e.g., cumulative coverage, image quality, and angle variation) can be analyzed using statistical or logical thresholds to determine termination conditions.

In one or more embodiments, rule-based or statistical approaches can be implemented in dynamic systems utilizing the dynamic termination mechanism provided in the present disclosure. These approaches can serve as a fallback or complementary solution for devices where deploying neural networks is not feasible due to hardware limitations or software constraints in certain situations.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Exemplary embodiments are described herein. Variations of those exemplary embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An input device comprising:
a fingerprint sensor comprising a plurality of sensor electrodes configured to obtain touch data; and
a processing system configured to:
initiate a fingerprint enrollment process to enroll a fingerprint of a user;
receive a first enrollment input based on the touch data obtained by the fingerprint sensor;
process the first enrollment input to extract one or more features corresponding to the fingerprint;
determine, based on the first enrollment input, whether to collect a second enrollment input; and
based on a determination not to collect a second enrollment input, generate a fingerprint template for the fingerprint, wherein the fingerprint template indicates a set of features extracted from one or more enrollment inputs processed in the fingerprint enrollment process, wherein the one or more enrollment inputs comprising the first enrollment input.

2. The input device according to claim 1, wherein processing the first enrollment input to extract the one or more features corresponding to the fingerprint comprises:
extracting, from the first enrollment input, one or more spatial features, wherein the one or more spatial features represent local characteristics; and
extracting, by comparing the first enrollment input with one or more prior enrollment inputs, one or more temporal features.

3. The input device according to claim 2, wherein the one or more temporal features represent connections between the first enrollment input and the one or more prior enrollment inputs, wherein the connections indicate one or more of transformations, overlap areas, and angles of variation between the first enrollment input and the one or more prior enrollment inputs.

4. The input device according to claim 2,
wherein extracting the one or more temporal features comprises:
extracting one or more temporal features by comparing the spatial features extracted from the first enrollment input with the spatial features extracted from each prior enrollment input of the one or more prior enrollment inputs.

5. The input device according to claim 2, wherein the processing system is configured to determine whether to collect a second enrollment input using a neural network,
wherein the processing system is further configured to:
generate an input to the neural network based on the one or more spatial features and the one or more temporal features; and
generate a binary classification indicating whether to collect a second enrollment input.

6. The input device according to claim 5, wherein the neural network is initialized when the fingerprint enrollment process is initiated.

7. The input device according to claim 1, wherein the processing system is further configured to:
based on a determination to collect a second enrollment input, collect the second enrollment input based on the touch data obtained by the fingerprint sensor;
process the second enrollment input to extract one or more features corresponding to the fingerprint;
determine, based on the second enrollment input, whether to collect a next enrollment input; and
based on a determination not to collect the next enrollment input, generate the fingerprint template for the fingerprint.

8. The input device according to claim 7, wherein the processing system is configured to:
generate a first sub-template based on the one or more features extracted from the first enrollment input;
generate a second sub-template based on the one or more features extracted from the second enrollment input; and
generate the fingerprint template by combining the first sub-template and the second sub-template.

9. The input device according to claim 1, wherein initiating the fingerprint enrollment process comprises setting a maximum number of enrollment inputs to be processed by the fingerprint enrollment process.

10. The input device according to claim 9, wherein the processing system is configured to:
end the enrollment process and generate the fingerprint template for the fingerprint, when a total number of processed enrollment inputs in the fingerprint enrollment process is greater than or equal to the maximum number of enrollment inputs.

11. A method for fingerprint enrollment, comprising:
initiating a fingerprint enrollment process to enroll a fingerprint of a user;
receiving a first enrollment input based on touch data obtained by a fingerprint sensor;
processing the first enrollment input to extract one or more features corresponding to the fingerprint;
determining, based on the first enrollment input, whether to collect a second enrollment input; and
based on a determination not to collect a second enrollment input, generating a fingerprint template for the fingerprint, wherein the fingerprint template indicates a set of features extracted from one or more enrollment inputs processed in the fingerprint enrollment process, wherein the one or more enrollment inputs comprise the first enrollment input.

12. The method according to claim 11, wherein processing the first enrollment input to extract the one or more features corresponding to the fingerprint comprises:
extracting, from the first enrollment input, one or more spatial features, wherein the one or more spatial features represent local characteristics; and
extracting, by comparing the first enrollment input with one or more prior enrollment inputs, one or more temporal features.

13. The method according to claim 12, wherein the one or more temporal features represent connections between the first enrollment input and the one or more prior enrollment inputs, wherein the connections indicate one or more of transformations, overlap areas, and angles of variation between the first enrollment input and the one or more prior enrollment inputs.

14. The method according to claim 12,
wherein extracting the one or more temporal features comprises:
extracting one or more temporal features by comparing the spatial features extracted from the first enrollment input with the spatial features extracted from each prior enrollment input of the one or more enrollment inputs.

15. The method according to claim 12, wherein determining whether to collect the second enrollment input is performed using a neural network,
wherein the method further comprises:
generating an input to the neural network based on the one or more spatial features and the one or more temporal features; and
generating a binary classification indicating whether to collect a second enrollment.

16. The method according to claim 15, wherein the neural network is initialized when the fingerprint enrollment process is initiated.

17. The method according to claim 11, further comprising:
based on a determination to collect a second enrollment input, collecting the second enrollment input based on the touch data obtained by the fingerprint sensor;
processing the second enrollment input to extract one or more features corresponding to the fingerprint;
determining, based on the second enrollment input, whether to collect a next enrollment input; and
based on a determination not to collect the next enrollment input, generating the fingerprint template for the fingerprint.

18. The method according to claim 17, further comprising:
generating a first sub-template based on the one or more features extracted from the first enrollment input;
generating a second sub-template based on the one or more features extracted from the second enrollment input; and
generating the fingerprint template by combining the first sub-template and the second sub-template.

19. The method according to claim 11, wherein initiating the fingerprint enrollment process comprises setting a maximum number of enrollment inputs to be processed by the fingerprint enrollment process.

20. A non-transitory computer-readable medium, having computer-executable instructions stored thereon for fingerprint enrollment, wherein the computer-executable instructions, when executed, cause one or more processors to perform:
initiating a fingerprint enrollment process to enroll a fingerprint of a user;
receiving a first enrollment input based on touch data obtained by a fingerprint sensor;
processing the first enrollment input to extract one or more features corresponding to the fingerprint;
determining, based on the first enrollment input, whether to collect a second enrollment input; and
based on a determination not to collect a second enrollment input, generating a fingerprint template for the fingerprint, wherein the fingerprint template indicates a set of features extracted from one or more enrollment inputs processed in the fingerprint enrollment process, wherein the one or more enrollment inputs comprise the first enrollment input.
